(19) United States
(12) Patent Application Publication
(10) Pub. No.: US 2010/0163762 A1
(43) Pub. Date: Jul. 1, 2010

(54) SYSTEM AND METHOD FOR MONITORING CONTROL STATUS OF AN EXHAUST APPARATUS PRESSURE CONTROL SYSTEM

(76) Inventor: Nambu Masahiro, Saitama (JP)

Correspondence Address: Neugeboren O'Dowd PC, 1227 Spruce Street, SUITE 200, BOULDER, CO, 80302, US

(21) Appl. No.: 12/540,055

(22) Filed: Aug. 12, 2009

Related U.S. Application Data
(63) Continuation-in-part of application No. 11/994,696, filed on Jun. 12, 2008.
(60) Provisional application No. 61/088,687, filed on Aug. 13, 2008.

(51) Int. Cl. G05D 16/20; F16K 31/12

(52) U.S. Cl. 251/28

(57) ABSTRACT

An exhaust pressure control apparatus is disclosed. The exhaust pressure control apparatus including a main body in which an inlet port and an outlet port are formed, the main body also including a pilot chamber. The system also includes a spool comprising an upper slide and a lower slide, the upper slide forming a movable portion of the pilot chamber, and the spool is held by the upper slide and the lower slide so that it can slide in an axial direction over a sliding surface connecting the intake port and the discharge port. A control system regulates a pressure in the intake port by controlling a pressure regulating gas supplied to the pilot chamber, and a control status portion provides an indication of the stability of the control system based upon the pressure in the pilot chamber.

### PRIORITY

The present application is a continuation-in-part of U.S. application Ser. No. 11/994,696, entitled EXHAUST APPARATUS PRESSURE CONTROL SYSTEM. The present application also claims priority to U.S. Provisional Application No. 61/088,687, entitled SYSTEM AND METHOD FOR MONITORING CONTROL STATUS OF AN EXHAUST APPARATUS PRESSURE CONTROL SYSTEM which is incorporated herein by reference.

### FIELD OF THE INVENTION

The present invention relates generally to systems for controlling the exhaust pressure of an exhaust apparatus.

### BACKGROUND

Oxidizing, diffusing, and CVD apparatuses and the like are configured such that various gasses are supplied to and caused to react in a chamber, after which the post-reaction gases are exhausted by an exhaust apparatus.

In such cases, when the internal pressure in the chamber changes very rapidly, the reaction in the chamber interior is adversely affected. For that reason, pressure control systems are provided in exhaust apparatuses, and control is effected so that the pressure of the gases exhausted is constant, irrespective of changes in the flow rate of the gases being exhausted or of pressure changes downstream from the exhaust apparatus.

Typical exhaust pressure controllers may utilize control valve voltage as an indicator of control status (e.g., to indicate whether control is stable). Utilizing the voltage of the control valve, however, is problematic because it is often an imprecise indicator of control status. As an example, under stable control conditions, monitoring that is based upon the voltage of the control valve may indicate the control is unstable due to temperature variations that adversely affect the voltage-based monitoring.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one embodiment, the invention may be characterized as an exhaust pressure control apparatus including a main body in which an inlet port and an outlet port are formed, the main body also including a pilot chamber. In addition, the apparatus includes a spool comprising an upper slide and a lower slide, the upper slide forming a movable portion of the pilot chamber, and the spool is held by the upper slide and the lower slide so that it can slide in an axial direction over a sliding surface connecting the intake port and the discharge port. A control system regulates a pressure in the intake port by controlling a pressure regulating gas supplied to the pilot chamber; and a control status portion provides an indication of the stability of the control system based upon the pressure in the pilot chamber.

### BRIEF DESCRIPTION OF THE DRAWINGS

FIG. 1 is a diagram of one example of an installation of a pressure control system according to an embodiment of the present invention.

FIG. 2 is a cut-a-way view of an exhaust apparatus pressure control system according to an embodiment of the present invention.

FIG. 3 is a block diagram depicting components of an exemplary embodiment of a control status component.

FIG. 4 is a cut-a-way view of an exhaust apparatus pressure control system according to an embodiment of the present invention.

FIG. 5 is a schematic view of an exemplary control portion of the exhaust apparatus pressure control system described with reference to FIG. 4.

FIG. 6 is a cut-a-way view of an exhaust apparatus pressure control system according to another embodiment of the present invention.

FIG. 7 is a graph depicting, under stable control pressure, the effect of temperature upon a monitored valve voltage as compared to the monitoring of ΔP.

FIGS. 8 and 9 are graphs depicting the effects of hysteresis upon valve voltage and ΔP, respectively.

FIGS. 10 and 11 are graphs depicting effects of house exhaust upon valve voltage and ΔP, respectively.

### DETAILED DESCRIPTION

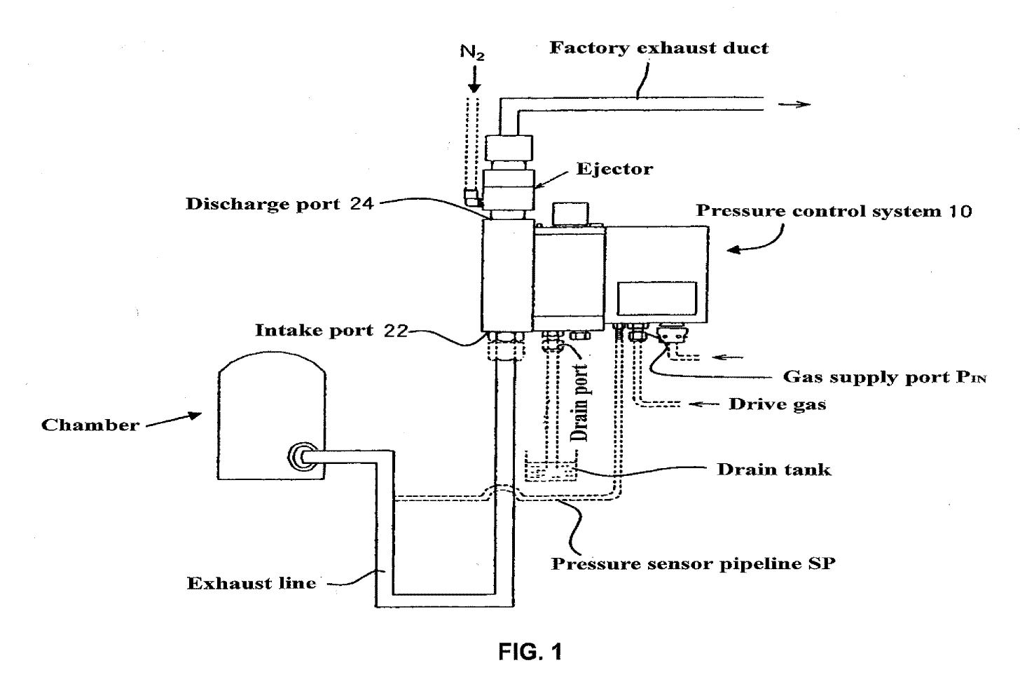

Referring first to FIG. 1, it is a diagram of one example of an installation of a pressure control system 10 of an embodiment of the present invention. As diagrammed in FIG. 1, the exhaust line from the processing chamber in an oxidizing, diffusing, or CVD apparatus or the like is connected to the intake port 22 of the pressure control system 10, and from a point midway along the exhaust line, the exhaust pressure is led by a pressure sensor pipeline SP to the pressure control system 10. As shown, an ejector is connected to the discharge port 24 of the pressure control system 10, and the discharge port of the ejector is connected to the factory exhaust duct. Nitrogen gas is supplied to the ejector for producing a suction force.

In operation, gases such as nitrogen are supplied to the interior of the pressure control system 10 from a gas supply port P_{IN}. The gases supplied from the gas supply port P_{IN} are used as the pressure regulating gas, a purge gas for protecting the sensors, a gas for making the spool movement smooth, and a gas for regulating the degree of opening of a valve unit. A liquid discharge drain port is provided in the lower part of the main body for when water vapor or the like discharged from the chamber is cooled and liquid accumulates. This drain port is connected by a drain tube to a drain tank.

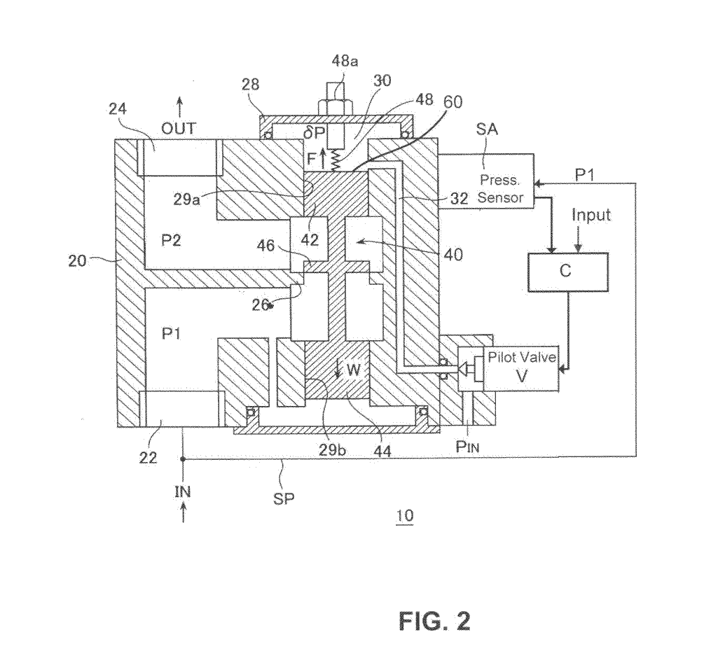

Referring next to FIG. 2, shown is a cut-a-way view of an exhaust pressure controller 10, which is referred to in order to convey an underlying principal of several embodiments of the present invention. As shown, a gas intake port 22 and discharge port 24 are formed in the main body 20, and a spool 40 is accepted by sliding surfaces 29a and 29b connecting the intake port 22 and the discharge port 24. In addition, a pilot chamber 30 is formed between a top cover 28 portion of the main body 20 and a surface 60 of an upper slide 42 portion of the spool 40 so that a movable portion of the pilot chamber 30 is formed by the surface 60 of the upper slide 42 of the spool 40.

Attached to the exterior of the main body 20 are an absolute pressure sensor SA for detecting the pressure at the intake port 22, a control valve V for supplying a pressure regulating gas such as nitrogen to the pilot chamber 30 through a pilot passageway 32, and a control circuit C for driving the control valve V based on an output from the absolute pressure sensor SA.

As depicted, a spool 40 is attached to the upper part of the main body by a spring 48, and an upper slide 42 and lower slide 44 (formed respectively above and below the spool 40) enables the spool 40 to slide in the axial direction relative to the sliding surfaces 29a and 29b of the main body 20. Also, at the center (relative to the axial dimension of the spool 40), a valve unit 46 is provided, corresponding to a valve seat 26 formed in the main body 20. When the spool 40 slides in an upward axial direction (toward the cover 28), a gap develops between the valve seat 26 and the valve unit 46 on the spool 40, and as a consequence, the intake port 22 and discharge port 24 communicate. As depicted, the elastic force F of the spring 48 holding the spool 40 can be adjusted by a spring adjustment screw 48a.

In many modes of operation, a pressure regulating gas is supplied to the pilot chamber 30 via the control valve V through the pilot passageway 32, and the gas is maintained so that the interior pressure δP of the pilot chamber 30 is substantially constant. Designating the force of the spring by F, the weight of the spool by W, the pressure in the inlet port 22 by P1, the gas pressure at the discharge port 24 by P2, the diameter of the valve in the spool 40 by d, and the internal pressure in the pilot chamber 30 by δP, then when the spool 40 is in a state of equilibrium, the formula:

P1=4/πd²·(W−F)+δP

will be true. Accordingly, the pressure P1 of the gas passing through the intake port 22 will be unrelated to the gas pressure P2 at the discharge port 24, but will be determined by the elastic force F of the spring and the internal pressure δP in the pilot chamber 30. By regulating the volume of pressure regulating gas supplied from the control valve V so as to make δP constant, the size of the gap between the valve seat 26 and the valve unit 46 will be controlled, and the gas pressure P1 at the intake port 22 will be maintained at a set value.

When the pressure P1 at the intake port 22 becomes higher than the set value for example, the lower slide 44 of the spool 40 will be pushed up, the spool 40 will rise in the axial direction (toward the cover 28), and the gap between the valve seat 26 and the valve unit 46 will become greater. As a consequence, more gas will flow out from the intake port 22 to the discharge port 24 side, and as a result, the pressure P1 at the intake port 22 will return again to the set value.

During normal control, that is, during film formation, the absolute pressure at the intake port 22 is controlled by having the pressure P1 at the intake port 22 detected by the absolute pressure sensor SA fed back to the control circuit C.

As shown, the spool working force may be expressed as:

F−W−1/4Πd²δP+1/4Πd²·P1=0

When control is stable, it has been found that the difference between the pilot chamber pressure δP and the intake port pressure P1 is substantially constant, and as a consequence, this difference (designated by ΔP) may be used as a precise indicator of the control status of the pressure control system 10, and may be expressed as:

ΔP=δP−P1=4/Πd²·(F−W)=constant

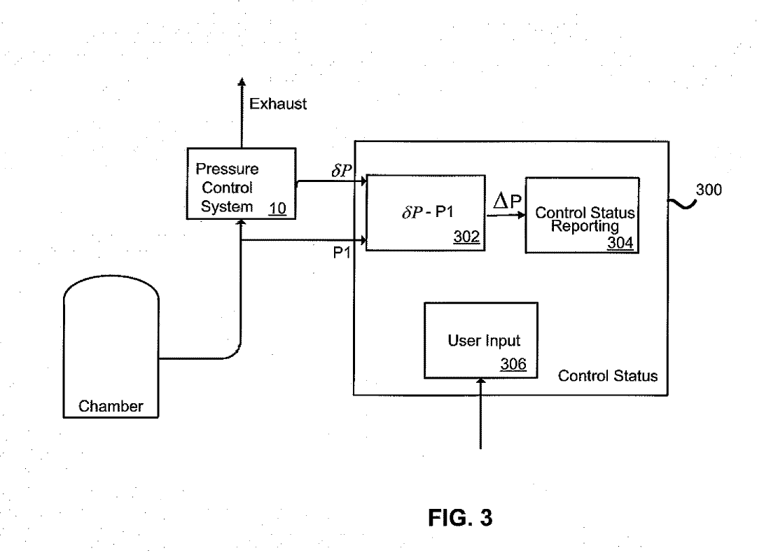

Referring next to FIG. 3, shown is a block diagram depicting components of a control status component 300. The control status component 300 in this embodiment is generally configured to provide status information (e.g., stability information) about the pressure control system 10 using the pilot pressure δP and the process chamber pressure P1. In this particular embodiment, the control status component 300 includes a ΔP component 302 that calculates ΔP by finding the difference between δP and the chamber pressure P1. In many embodiments, the ΔP component 302 includes a differential pressure sensor, which senses both the pilot pressure δP and the chamber pressure P1 and provides an output that is indicative of ΔP. In other embodiments, however, ΔP may be arrived at by processing (e.g., obtaining the difference between) the output of two separate pressure sensors: one that senses the pilot pressure P1 and one that senses the chamber pressure P1.

In addition, the control status component 300 includes a reporting component 304 (e.g., an output to a display, a display, or other reporting device) that provides an indication (e.g., to a system user) of the status of the pressure control system 10. As discussed above, ΔP is substantially constant when the pressure control system 10 is stable; thus the reporting component 304 provides an indication of the system 10 stability based upon any variations in ΔP.

Also depicted is a user input 306, which generally operates to receive one or more inputs from a user in connection with operation of the control status component 300. In some embodiments for example (as discussed further herein) the user input 306 may initiate a reconfiguration of one or more components of the control system 10 so that one or more components of the control status component 300 are realized by one or more components of the control system 10. It should be recognized that the depiction of components of the control status component 300 is merely logical and is not intended to be a hardware diagram. Thus, the components can be combined or further separated in an actual implementation. Moreover, the construction of each individual component (which may include a combination of hardware, software, and/or firmware), in light of this specification, is well-known to those of skill in the art.

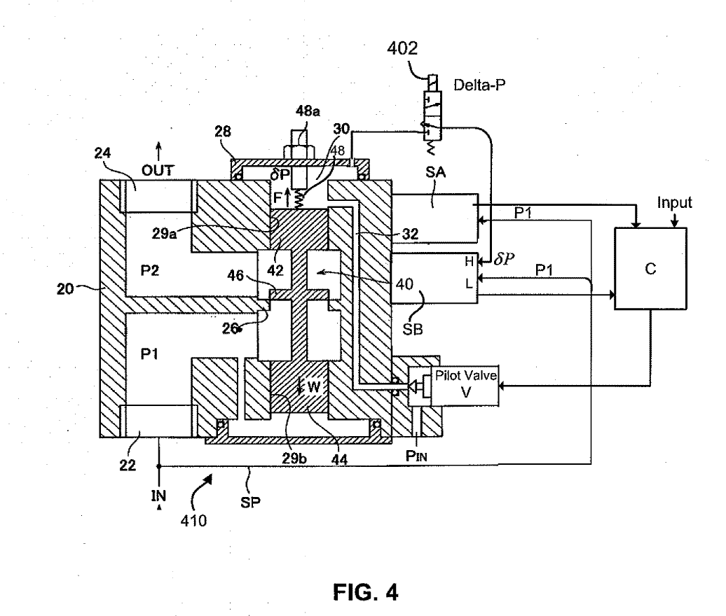

Referring next to FIG. 4, shown is a diagram of an exemplary embodiment of an exhaust apparatus pressure control system in accordance with the present invention. This embodiment may be realized by adapting the exhaust apparatus pressure control system disclosed in Japanese Application JP2005-195315 filed Jul. 4, 2005 and corresponding U.S. patent application Ser. No. 11/994,696, which are incorporated herein by reference.

As described in the two above-identified applications, this embodiment also includes a differential pressure sensor SB for detecting the difference between the atmospheric pressure and the pressure at the intake port 22, and the control circuit C is adapted to switch between the absolute pressure sensor SA and the differential pressure sensor SB and drive the control valve V based on outputs from the absolute pressure sensor SA or differential pressure sensor SB. For example, when control status is not being observed, the pressure P1 is controlled utilizing the output of pressure sensor SA, and the delta-P valve 402 (also referred to herein as delta-P switch), which may be realized by a 3-port 2-valve device, is disposed so that the H-line of pressure sensor SB is coupled to atmospheric pressure so that the output of pressure sensor B is indicative of the differential pressure between P1 (input on the L-line of SB) and the atmospheric pressure (input on the H-line). And when the process chamber opens, the pressure sensor SB is then utilized to control the pressure of P1 so that the pressure of P1 is near or at atmospheric pressure.

When a user desires to obtain control status information, the delta-P valve 402 is adjusted so that the H-line of pressure sensor SB is coupled to the pilot pressure δP (the L-line of pressure sensor SB remains coupled to pressure P1); thus ΔP may then be obtained by monitoring the output of differential pressure sensor SB. Thus in this embodiment, the pressure sensor SB is utilized in both the control system 10 and the control status component 300.

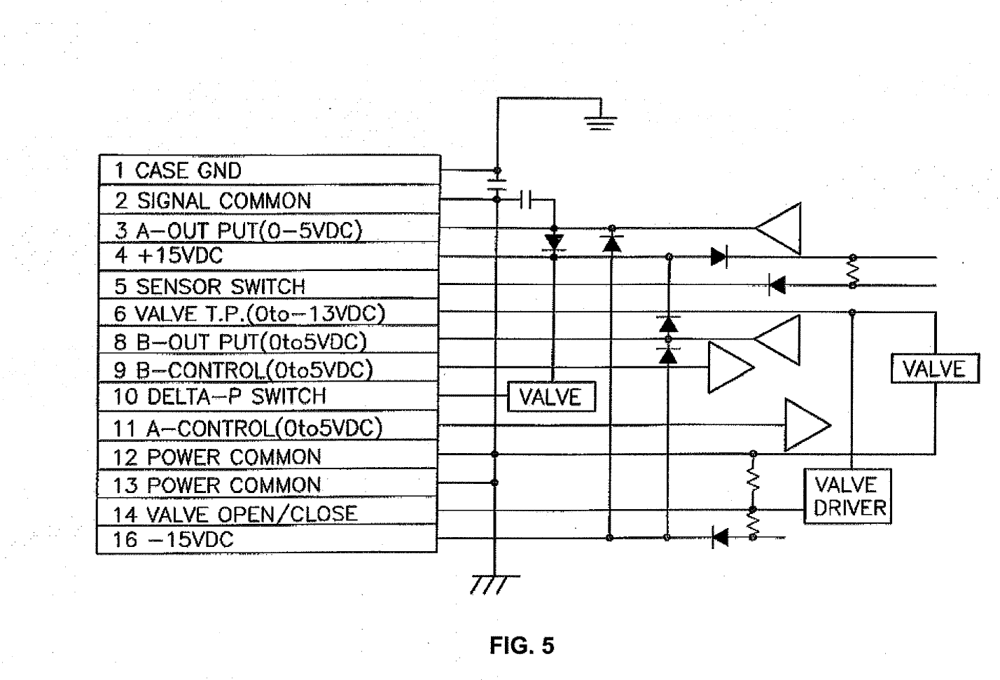

Referring next to FIG. 5, shown is an exemplary embodiment of the control circuit C described with reference to FIG. 4. In this embodiment, the voltage outputs from the absolute pressure sensor SA and the differential pressure sensor SB appear on pin number 3 and pin number 8, and provision is made so that the pressure at the intake port 22 can be detected. During normal control (during film formation), absolute pressure control is effected, so the voltage output from the absolute pressure sensor SA will appear on pin number 3 and simultaneously be taken into a comparison control circuit in the control circuit. While comparing this with a setting signal sent through pin number 11 from the outside, the pressure regulating gas from the control valve V is regulated and the valve unit 46 is controlled.

When the interior of the processing chamber is atmospheric pressure, the pressure sensor that is utilized is switched from the absolute pressure sensor SA to the differential pressure sensor SB by applying a sensor switching-signal input to pin number 5, and the voltage from the differential pressure sensor SB (corresponding to the atmospheric pressure) is applied to pin number 9, and the control valve V is regulated using the sensor SB.

When returning again to normal control, by cutting off the sensor switching signal on pin number 5, the sensor taken into the comparison control circuit is switched from the differential pressure sensor SB to the absolute pressure sensor SA, and control of the valve V is based upon the absolute pressure sensor SA. During normal control, the output from the differential pressure sensor SB is monitored with pin number 8, and if the atmospheric pressure drops (e.g., due to a typhoon or the like) an alarm output is issued so that the pressure inside the processing chamber does not become higher than the atmospheric pressure, thus preventing a mishap before it can happen.

As shown in FIG. 5, when control status information is desired, Pin 10 (delta-P switch) is coupled with Pin 12 (power common) so that the valve (also referred to as a delta-p switch) 402 is turned ON so as to couple the pilot chamber 30, and hence the pilot pressure δ, to the H-line of pressure sensor SB. The output of pressure sensor SB is then utilized to provide an indication of the status of the exhaust control system 410 (e.g., an indication of the stability of the exhaust control system 410).

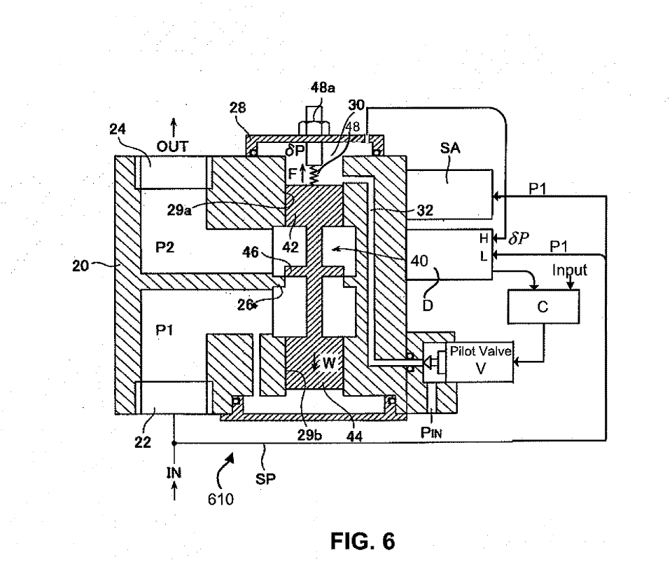

Referring next to FIG. 6, shown is another diagram of an exemplary embodiment of an exhaust apparatus pressure control system in accordance with the present invention. This embodiment may be realized by adapting the exhaust apparatus pressure control system disclosed in U.S. Pat. No. 6,237,635, which is incorporated herein by reference. As shown, in this embodiment, an additional sensor D is added and utilized to provide an output that is indicative of ΔP based upon δP and P1 inputs via lines depicted as H and L, respectively.

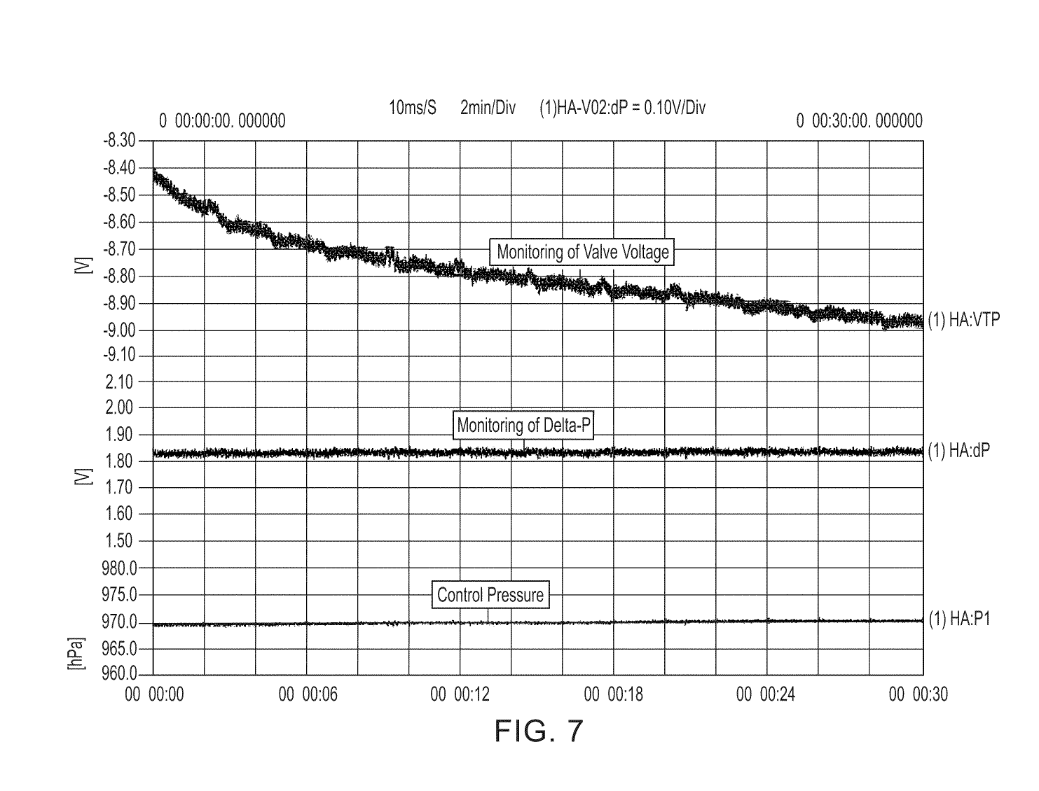

Referring next to FIG. 7, shown is a graph depicting, under stable control pressure, the effect of temperature upon a monitored valve voltage and the monitoring of ΔP (e.g., the ΔP obtained in the embodiments depicted in FIGS. 4 and 5) under the same temperature conditions. As shown, the monitored control valve voltage is adversely affected by the temperature variation while the monitored ΔP remains steady; thus monitoring based upon ΔP provides a more precise indication of control status as compared to monitoring that is based upon control valve voltage.

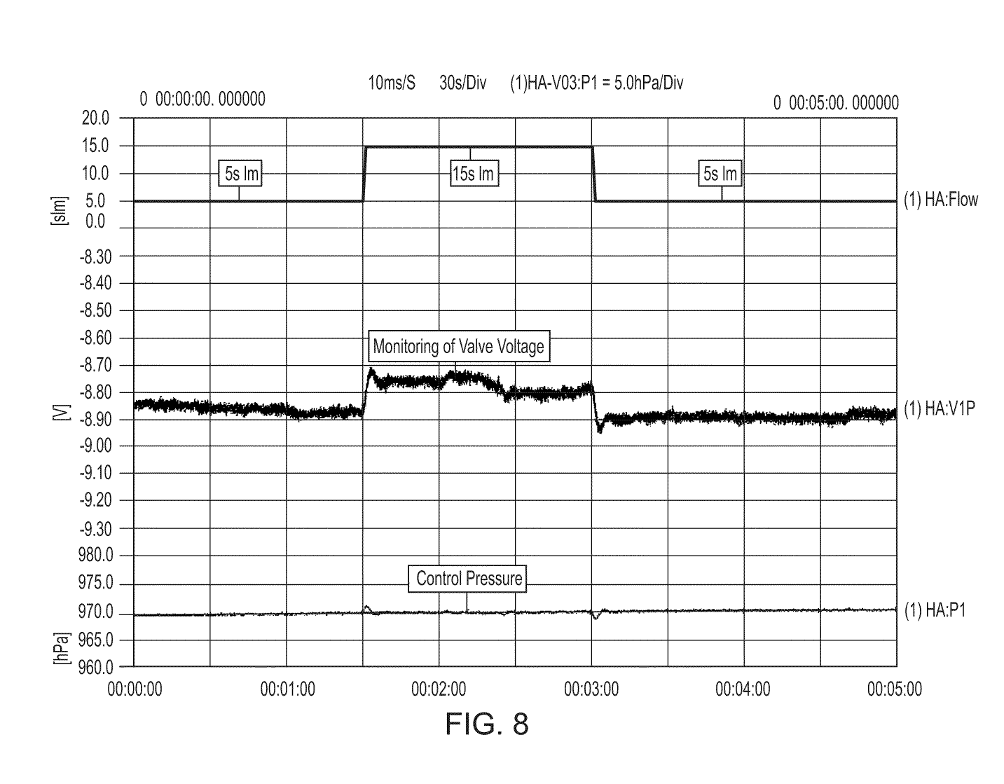

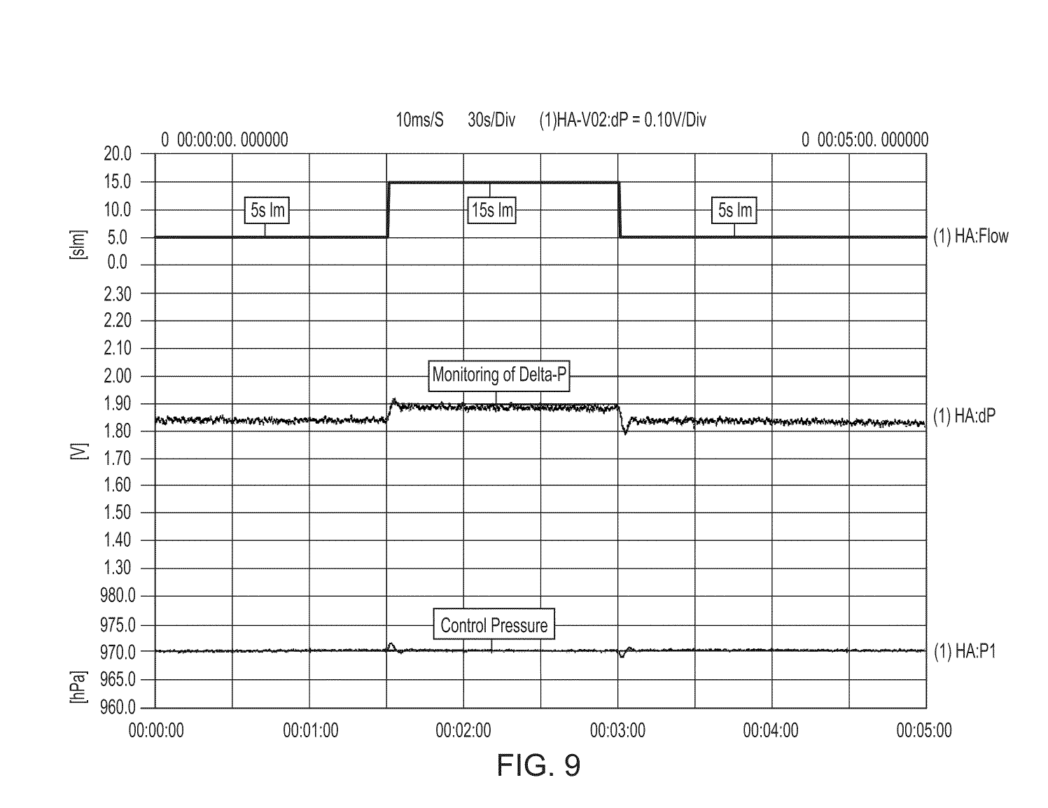

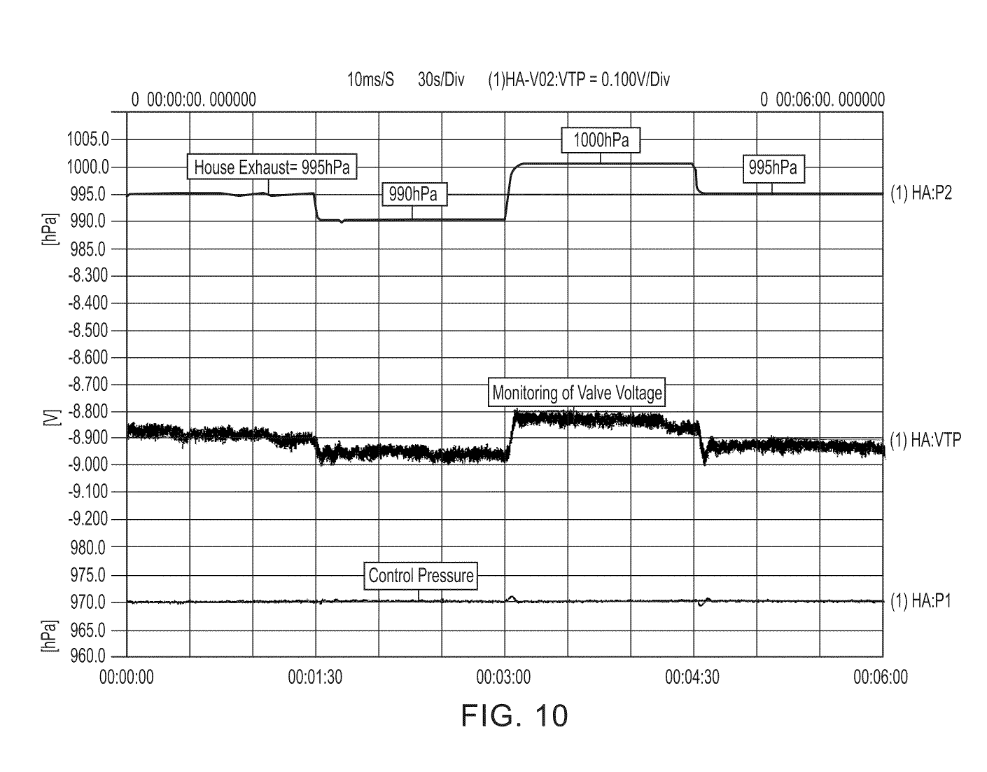

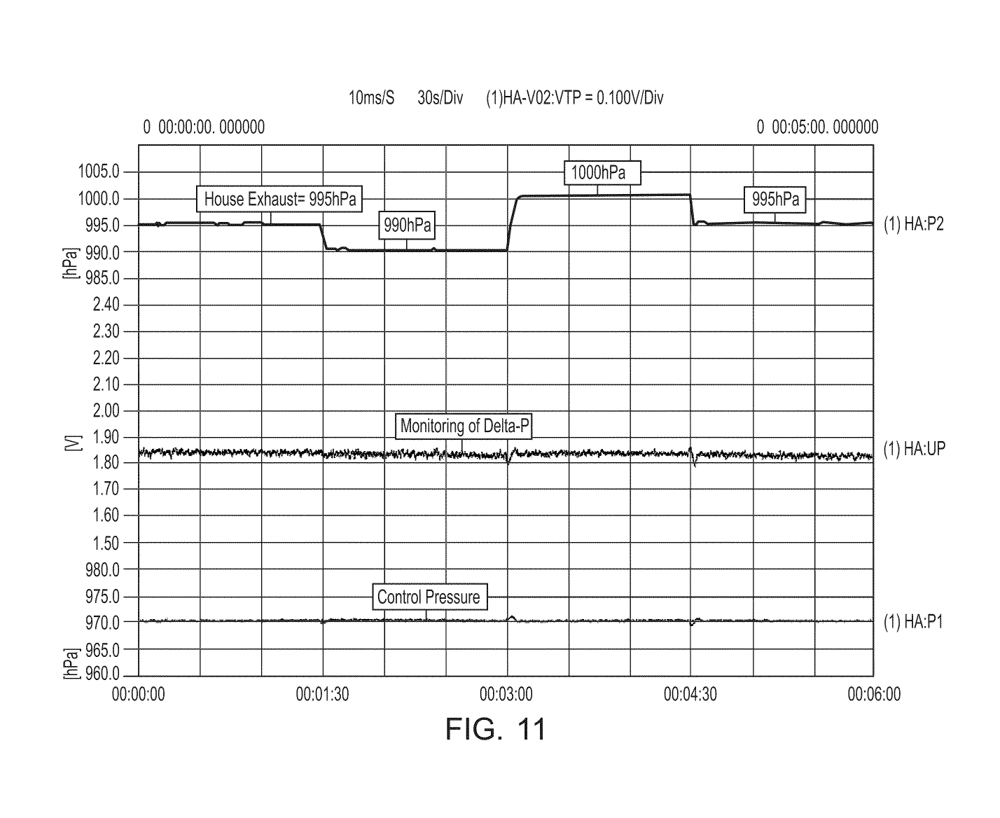

Referring to FIG. 8, it can also be seen that monitoring valve voltage also has the drawback of being susceptible to hysteresis whereas, as depicted in FIG. 9, the monitoring of ΔP does not have this disadvantage. Moreover, as shown in FIG. 10, monitoring valve voltage is also adversely affected by changes in house exhaust, and house exhaust is linked with atmospheric pressure; thus monitoring of valve voltage may also be adversely affected by atmospheric pressure change. In contrast, as shown in FIG. 11, monitoring ΔP does not show any substantial adverse effects from changes in house exhaust.

What is claimed is:

1. An exhaust pressure control apparatus comprising:
a main body in which an inlet port and an outlet port are formed, the main body also including a pilot chamber;
a spool comprising an upper slide and a lower slide, the upper slide forming a movable portion of the pilot chamber, and the spool is held by the upper slide and the lower slide so that it can slide in an axial direction over a sliding surface connecting the intake port and the discharge port;
a control system to regulate a pressure in the intake port by controlling a pressure regulating gas supplied to the pilot chamber; and
a control status portion configured to provide an indication of the stability of the control system based upon the pressure in the pilot chamber.

2. The exhaust apparatus pressure control apparatus of claim 1, wherein the control status portion includes a differential pressure sensor arranged so as to provide the indication of the stability of the control system based upon a difference between the pressure in the pilot chamber and a pressure in the intake port.

3. The exhaust apparatus pressure control apparatus of claim 2, wherein the differential pressure sensor is coupled to the intake port and atmospheric pressure, and responsive to a control-status query, a control circuit sends switching signals to uncouple the differential pressure sensor from atmospheric pressure and couple the differential pressure sensor to the pilot chamber.

4. The exhaust apparatus pressure control apparatus according to claim 1, wherein the control system includes:
an absolute pressure sensor; and
a control valve disposed to modulate a flow of the pressure regulating gas supplied to the pilot chamber, the control system driving the control valve based upon an output of the absolute pressure sensor.

5. The exhaust apparatus pressure control apparatus according to claim 4, wherein the control system includes a differential pressure sensor coupled to atmospheric pressure and the intake port, and the control system drives the control valve based on the output from the absolute pressure sensor or differential pressure sensor.

6. The exhaust apparatus pressure control apparatus according to claim 5, wherein the control status portion includes the differential pressure sensor, and responsive to a control-status query, a control circuit sends switching signals to uncouple the differential pressure sensor from atmospheric pressure and couple the differential pressure sensor to the pilot chamber.
